(19) United States
(12) Patent Application Publication
(10) Pub. No.: US 2003/0223018 A1
(43) Pub. Date: Dec. 4, 2003

(54) Power supply feedback circuit

(76) Inventor: Tsuginori Ohnishi, Takefu-City (JP)

Correspondence Address: WENDEROTH, LIND & PONACK, L.L.P., 2033 K STREET N. W., SUITE 800, WASHINGTON, DC, 20006-1021, US

(21) Appl. No.: 10/447,226

(22) Filed: May 29, 2003

(30) Foreign Application Priority Data
May 29, 2002 (JP) 2002-155220

(51) Int. Cl. H04N 5/63

(52) U.S. Cl. 348/730

(57) ABSTRACT

A power supply feedback circuit for detecting a voltage of a secondary side of a transformer provided to a power supply circuit surely and stably and controlling a control microcomputer by supplying a proper voltage from a transformer to a control microcomputer.

The power supply feedback circuit 20 according to the present invention, which detects a voltage of the secondary side of the transformer 10 provided to the power supply circuit and outputs feedback signals for controlling an input of the primary side of the transformer 10, is provided with a feedback signal output element 5 for outputting feedback signals in response to a voltage of the secondary side of the transformer 10 and a semiconductor control element 6 for controlling feedback signals in response to a voltage of the second side of the transformer 10.

The feedback signal output element 5 is connected to a second secondary side output terminal 12 of the transformer 10 outputting an operation voltage for a control microcomputer. The semiconductor control element 6 is connected to a first secondary output terminal 11 of the transformer 10 outputting an operation voltage for a YV monitor in order to control the feedback signal output element 5 in response to a voltage of the first secondary output terminal 11.

### TECHNICAL FIELD

The present invention relates to a power supply feedback circuit which detects a voltage on the output side of a power supply circuit for operating a TV monitor and gives a feedback to the input side of the power supply circuit and controls the voltage on the output side of the power supply circuit.

### BACKGROUND ART

A power supply circuit for operating a TV monitor is provided with a transformer which outputs a voltage for operating a TV monitor from a secondary side output terminal in response to a power supplied to a primary side input terminal.

The secondary side output terminal of the transformer is comprised of a plurality of terminals such as a terminal for outputting a voltage in order to operate a TV monitor, a terminal for outputting a voltage in order to operate a control microcomputer, and the like. And, each of these secondary side output terminals outputs a different voltage in response to an operating voltage of a TV monitor or a microcomputer.

Furthermore, the power supply circuit for operating the TV monitor is provided with a power supply feedback circuit which detects a voltage of a secondary side output terminal of the transformer and controls a voltage to be inputted to a primary side input terminal.

In this regard, more detailed explanation is made as follows. When a voltage of the secondary side output terminal of the transformer fluctuates, a normal operation of the TV monitor cannot be attained. In view of this, a power supply feedback circuit, which detects a voltage of a secondary side output terminal of the transformer and outputs a feedback signal in response to the detected voltage, is provided at the power supply circuit for operating the TV monitor. By doing so, a voltage to be inputted to the primary side input terminal of the transformer is controlled, and a proper voltage is outputted from a secondary side output terminal.

However, there is such a case that a conventional power supply feedback circuit cannot surely detect a fluctuation of a voltage at a secondary side of a transformer. In such a case, a control microcomputer cannot be operated normally, and the operation of a TV monitor cannot be controlled, so that the TV monitor cannot be operated normally.

### DISCLOSURE OF INVENTION

It is, therefore, an object of the present invention to provide a power supply feedback circuit which can surely detect a fluctuation of a voltage at a secondary side of a transformer provided in a power supply circuit and surely controls the transformer.

In order to attain the above objects, the power supply feedback circuit according to the present invention is connected to:

a power supply circuit for a TV monitor which has a transformer having a primary side input terminal, a first secondary side output terminal for outputting a voltage for operating a TV monitor and a secondary side output terminal for outputting a voltage for operating a control microcomputer,

wherein the power supply feedback circuit detects a voltage of the first secondary side output terminal and a voltage of the second secondary side output terminal and outputs a feedback signal for controlling an electric power for said primary input terminal of the transformer; and

provided with a feedback signal output element which outputs the feedback signal in response to a conducting current and a semiconductor control element which controls the feedback signal output element, and

wherein the feedback signal output element is connected to the second secondary side output terminal and is connected so as to be supplied a current in response to the voltage of the second secondary side output terminal, and

wherein the semiconductor control element is connected to detect the voltage of the first secondary side output terminal and so as to control the current conducting the feedback signal output element in response to the detected voltage of the first secondary side output terminal.

In the power supply feedback circuit according to the present invention, the voltage of the first secondary side output terminal and the voltage of the second secondary side output terminal are detected by the semiconductor control element and the feedback signal output element, and the feedback signal output element outputs a feedback signal in response to the detected voltage, thereby controlling the transformer.

Since the feedback signal output element is connected to the second secondary output terminal, a fluctuation of a voltage of the secondary side output terminal of a transformer which operate a control microcomputer can be detected without switching the connection of a secondary side of the transformer by a switch or the like.

Thus, the operation of a circuit at the secondary side of the transformer provided with the semiconductor control element is not made to be unstable, and a fluctuation of a voltage which operates a control microcomputer, can be detected surely and stably. In addition, the feedback signal output element may be connected, via a voltage absorption element inducing a certain amount of voltage drop, to the second secondary side output terminal of the transformer.

In the power supply feedback circuit according to the present invention, a voltage lower than the voltage of the second secondary side output terminal of the transformer by the certain amount of voltage drop induced by the voltage absorption element is applied to the feedback signal output element, and in this state of a voltage drop, the feedback signal output element detects a voltage of the second secondary side output terminal of the transformer, so that the detection sensitivity for this voltage fluctuation is enhanced and the transformer can be controlled with higher accuracy. Thus, a voltage for the control microcomputer can be supplied with higher accuracy.

Furthermore, the feedback output element may be constituted of a photo coupler. When a photo coupler is applied to the feedback signal output element, due to the relation between a secondary side voltage of the transformer to be inputted to the photo coupler, a conductive current conducted in the photo coupler, and a feedback signal outputted from the photo coupler, the transformer can be easily controlled on the basis of the relation between the detected secondary side voltage of the transformer and a feedback signal.

### BRIEF DESCRIPTION OF DRAWINGS

FIG. 1 is a circuit diagram of a power supply circuit including the power supply feedback circuit according to the present invention; and

FIG. 2 is a circuit diagram of a power supply circuit including a power supply feedback circuit of a comparison example.

### BEST MODE FOR CARRYING OUT THE INVENTION

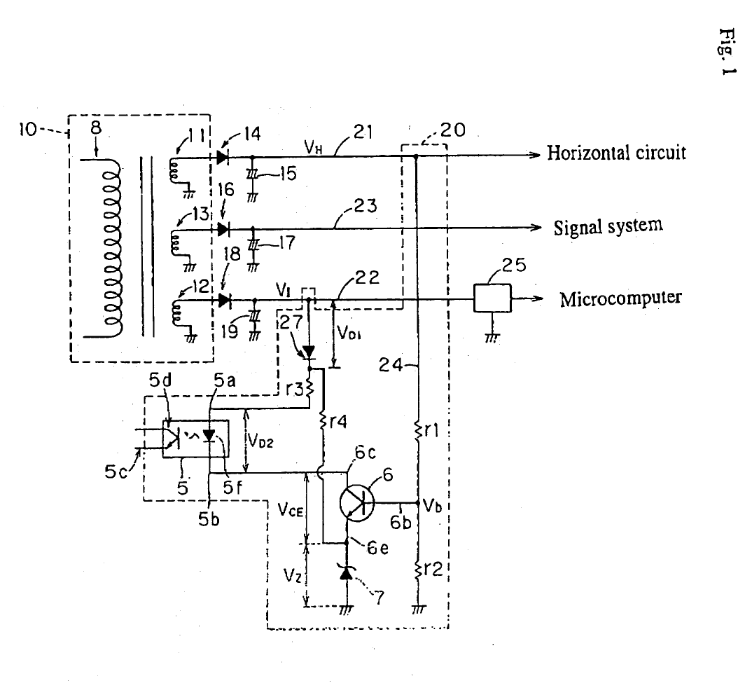

The invention will now be described in greater detail with reference to the accompanying drawings. FIG. 1 is a circuit diagram showing a connection of the power supply circuit for a TV monitor. A power supply feedback circuit 20 according to the present invention is connected as a part of the power supply circuit for a TV monitor shown in FIG. 1.

In FIG. 1, a numeral 10 depicts a transformer. The transformer 10 is provided with a primary side input terminal 8 and three secondary output terminals 11, 12, and 13. The primary side input terminal 8 of the transformer 10 is supplied with an AC power from an AC power source, not shown.

A power applied to the primary side input terminal 8 of the transformer 10 is controlled, in response to a feedback signal outputted from a photo coupler 5, explained hereunder, of the power supply feedback circuit 20, by an input control circuit, not shown.

A first secondary side output terminal 11 of the transformer 10 outputs a voltage for operating a TV monitor, a second secondary side output terminal 12 outputs a voltage for operating a control microcomputer, and a third secondary side output terminal 13 outputs a voltage for operating each circuit of signal systems.

Each of secondary side coils of the transformer 10 is formed, in conformity with outputs from each of the secondary side output terminals 11, 12 and 13, with a certain turn ratio in comparison with primary side coils. And, the output from each of secondary output terminals of the transformer 10 is controlled such that only the cycles whose voltages in the alter current voltage are positive are outputted by diodes 14, 16 and 18.

Each of the secondary side output terminals 11, 12 and 13, as shown in FIG. 1, is connected with the diode in a forward direction and a smoothing condenser to be connected to the ground so as to be supplied with a positive voltage. For example, the first secondary side output terminal 11 is connected with a diode 14 in a forward direction and a smoothing condenser 15 connected between a cathode side of the diode 14 and the ground at the cathode side of the diode 14.

The first secondary side output terminal 11 is connected, via the diode 14, with a TV monitor operation line 21. The TV monitor operation line 21, which is connected to a horizontal circuit of a TV monitor, transmits a voltage outputted from the first secondary side output terminal 11 to the horizontal circuit of a TV monitor. In the case of normal operation, a proper voltage V_{N} for normally operating a TV monitor is outputted from the fist secondary side output terminal 11 to the TV monitor operation line 21.

The second secondary side output terminal 12 is connected, via the diode 18, with a microcomputer input line 22. The microcomputer input line 22 is connected to an operation voltage terminal of a control microcomputer, and transmits an output of the second secondary output terminal 12 to the microcomputer. In the case of normal operation, a proper voltage V_{M} for normally operating a microcomputer is outputted from the second secondary side output terminal 12 to the microcomputer input line 22. Further, a regulator 25 is provided in the midst of the microcomputer input line 22, and a voltage of the microcomputer input line 22 is regulated so as to be a prescribed voltage, and inputted to a micro computer.

The third secondary side output terminal 13 is connected, via a diode 16, with a signal system operation line 23. The signal system operation line 23 is connected to operating voltage terminals of each of signal system circuits, and transmits an output of the third secondary output terminal 13 to each of signal system circuits. Signal system circuits are connected with a circuit for processing a video signal, a circuit for actuating a motor of a video deck, a circuit for operating a tuner or the like.

In FIG. 1, the numeral 20 shows the power supply feedback circuit according to the present invention. The power supply feedback circuit 20 is provided with a voltage detection circuit 24, a photo coupler 5, and a transistor 6.

One end of the voltage detection circuit 24 is connected to the TV monitor operation line 21 and the other end is grounded. Further, the voltage detection circuit 24 is connected with two resistors r1 and r2 in series, and a base terminal 6b of a transistor 6 is connected between the resistors r1 and r2. To the voltage detection circuit 24, a voltage V_{H} outputted from the first secondary side output terminal 11 of the transformer 10 to the TV monitor operation line 21 is transmitted.

An input terminal 5a on the side of a light emitting diode of the photo coupler 5 is connected, via a diode 27 and a resistor 3 which are connected in series, to the microcomputer input line 22, and an output terminal 5b on the side of a light emitting diode of the photo coupler 5 is connected to a collector terminal 6c of the transistor 6.

An anode of the diode 27 is connected to the microcomputer input line 22, and a cathode of the diode 27 is connected to one end of the resistor r3. And, the other end of the resistor r3 is connected to the input terminal 5a on the side of a light emitting diode of the photo coupler 5.

The photo coupler 5 is provided with a light emitting diode 5f and a photo-detector 5d. In the photo coupler 5, a light emitting diode 5f is driven to emit light by a current which is inputted from the input terminal 5a on the side of a light emitting diode and outputted, through the light emitting diode 5f, from the output terminal 5b on the side of a light emitting diode.

The light emitting diode 5f emits with brightness in response to the conducting current. And, in response to the amount of the light of the light emitting diode 5f, the photo detector 5d outputs a detection signal through an output terminal 5c on the side of the photo detector 5d. The outputted detection signal is transmitted to the primary side of the transformer 10, thereby controlling a power inputted to the primary side of the transformer 10.

A conducting current, which conducts the input terminal 5a on the side of a light emitting diode of the photo coupler 5, the light emitting diode 5f, and the output terminal 5b on the side of a light emitting diode, varies depending on the voltage of the microcomputer input line 22 or the operation condition of the transistor 6.

The photo coupler 5 corresponds to a feedback signal element, and a detection signal outputted from the photo coupler 5 corresponds to a feedback signal.

The base terminal 6b of the transistor 6 is connected between the resistors r1 and r2 which are provided to the voltage detection circuit 24. The collector terminal 6c of the transistor 6 is connected to the output terminal 5b on the side of a light emitting diode of the photo coupler 5.

An emitter terminal 6e of the transistor 6 is grounded via a Zener diode 7. And, the emitter terminal 6e is connected, via the resistor r4, to a cathode of the diode 27 and one end of the resistor r3.

For the voltage V_{H} outputted to the TV monitor operation line 21, a voltage derived from the resistor r2 is applied to the base terminal 6b of the transistor 6. Namely, a voltage determined by Vb=V_{H}B·r2/(r1+r2) is applied to the base terminal 6b of the transistor 6.

The voltage Vb applied to the base terminal 6b of the transistor 6 varies in response to the variation of a voltage transmitted from the TV monitor operation line 21 to the voltage detection circuit 24. Thus, the operation condition of the transistor 6 varies.

In the transistor 6, when the voltage Vb is reduced, a current conducting between the collector 6c and the emitter 6e is reduced. And, a conductive current, which conducts through the input terminal 5a on the side of a light emitting diode of the photo coupler 5 and the output terminal 5b, is reduced. Consequently, detection signals outputted from the output terminal 5c on the side of the photo detector of the photo coupler 5 are reduced.

On the other hand, in the transistor 6, when the voltage Vb is increased, a current conducting between the collector 6c and the emitter 6e is increased. And, a conducting current, which conducts the input terminal 5a on the side of a light emitting diode of the photo coupler 5 and the output terminal 5b, is increased. Thus, detection signals outputted from the output terminal 5c on the side of the photo detector of the photo coupler 5 are increased.

Thus, the transistor 6 detects a voltage transmitted from the TV monitor operation line 21 to the voltage detection circuit 24 and controls a current of the photo coupler 5, and controls a detection signal (a feedback signal) outputted from the photo coupler 5. The transistor 6 corresponds to a semiconductor element for controlling the photo coupler 5.

And, the diode 27, the transistor r3, the photo coupler 5, the transistor 6, and the Zener diode 7 can be selected as follows.

When a voltage V_{I} outputted to the microcomputer input line 22 is a proper voltage V_{M}, the above elements are selected in order that the voltage V_{I} exceeds the total voltage of a voltage drop V_{D1} in a forward direction of the diode 27, a voltage drop Vᵣ₃ by the resistor r3, a voltage drop V_{D2} of the light emitting diode 5f, a voltage drop V_{CE} between the collector 6c—the emitter 6e of the transistor 6, and a threshold voltage V_{Z} of the Zener diode 7.

Namely, when the voltage V_{I} does not exceed the total voltage of V_{D1}, Vᵣ₃, V_{D2}, V_{CE}, and V_{Z}, a current cannot be conducted between the input terminals 5a-5b of the photo coupler 5, and a feedback signal cannot be outputted from the output terminal 5c.

When a voltage V_{I} outputted to the microcomputer input line 22 is a proper voltage V_{M}, each element is selected in order that V_{D2} and the voltage drop Vᵣ₃ depending on the current conducting the resistor r3 are decided due to the relation between V_{I}, V_{D1}, V_{Z} and V_{CE}, and that an output to the microcomputer input line 22 takes the voltage V_{M} by the feedback signal which is outputted based on the voltage V_{D2} of the light emitting diode 5f.

The power supply feedback circuit 20 is preferable, because a diode 27 is provided and it is able to give a feedback to the primary side of the transformer 10 more precisely for the fluctuation of the voltage of the microcomputer input line 22.

In other words, a peculiar and constant voltage drop V_{D1} is induced at the diode 27. Accordingly, for the voltage V_{I} of the microcomputer input line 22, a voltage (V_{I}-V_{D1}), in which a voltage drop V_{D1} is reduced from the voltage V_{I} of the microcomputer input line 22, is applied to the input terminal 5a of the photo coupler 5.

And, it is adjusted such that, in combination with the voltage drop V_{D1} induced by the diode 27, the proper voltage drop V_{D2} (i.e., a proper voltage V_{M} is outputted to the microcomputer input line 22 due to a feedback signal based on a proper voltage V_{D2}.) between the terminals 5a-5b of the photo coupler 5 against the above-described proper voltage V_{M} is decided. Thus, the variation of the voltage V_{I} of the microcomputer input line 22 can be detected with higher accuracy, and the primary side of the transformer 10 can be controlled with high accuracy. The diode 27 corresponds to a voltage absorption element which induces a certain amount of voltage drop.

A voltage for operating a control microcomputer is strictly defined (in a normal case, a voltage of 5V is adopted), so that strict conditions are required for the variation of voltage. Namely, this is because abnormal operations are induced by the variation of voltage to be inputted to a microcomputer resulting from conditions for the power supply and an environment al conditions such as temperature.

As explained heretofore, the power supply feedback circuit 20 in the present invention is provided with the diode 27, so that the voltage variation of the secondary side output terminal 12 of the transformer 10 can be controlled with high accuracy. Thus, the power supply feedback circuit 20 is preferable, because an operating voltage can be supplied to a control microcomputer with high accuracy.

In providing a voltage absorption element, though the example in which the normal diode 27 is shown in FIG. 1, a Zener diode may be provided instead of the normal diode.

Namely, a cathode side of the Zener diode is connected to the side of the microcomputer input line 22, and an anode side of the Zener diode is connected to the side of the photo couple 5. When the Zener diode is connected in this way, for the voltage V_{I} of the microcomputer input line 22, a voltage (V_{I}-V_{TZ}), in which a reverse tolerance voltage V_{TZ} of the Zener diode is reduced from the voltage V_{I} of the microcomputer input line 22, is applied to the input terminal 5a of the photo coupler 5.

In this case, when the voltage applied from the microcomputer input line 22 to the Zener diode is less than a reverse tolerance voltage, the photo coupler 5 cannot be activated, and a feedback signal cannot be outputted from the photo coupler 5. Thus, a voltage reduction of the microcomputer input line 22 can be detected, and a feedback can be given to the primary side of the transformer 10.

When implementing the present invention, it is not necessarily required to provide a voltage absorption element. As explained heretofore, however, when the voltage absorption element is provided, the voltage variation of the secondary side output terminal 12 of the transformer 10 can be controlled with high accuracy. Therefore, an operating voltage can be supplied to a control microcomputer with high accuracy.

Next, operation examples with respect to the above described power supply feedback circuit will be explained as follows.

(1) Operation Example in an Operation Mode

An operation example in an operation mode for operating a TV monitor will be explained. First, an operation switch of a TV monitor is turned ON, and the operation of the TV monitor is started. Thereby, video pictures are displayed on a display screen.

When a voltage of the first secondary side output terminal 11 of the transformer 10 is reduced to be lower than a proper voltage, the voltage V_{H}, which is transmitted from the TV monitor operation line 21 to the voltage detection circuit 24, is also reduced.

Accordingly, a voltage Vb applied to the base terminal 6b of the transistor 6 is reduced, and a current that can be conducted from the collector 6c to the emitter 6e is reduced. And when a proper voltage is outputted from the second secondary output terminal 12 of the transformer 10, a current which conducts from the light emitting diode side input terminal 5a of the photo coupler 5 to the output terminal 5b is reduced, and a feedback signal outputted from the detection signal output terminal 5c is reduced.

And, due to the reduction of the feedback signals outputted from the photo coupler 5, an electric power inputted to the primary side input terminal 8 of the transformer 10 is controlled so as to increase. Accordingly, a voltage outputted from the secondary side output terminal 11 of the transformer 10 is increased to be a proper voltage.

Thereafter, when a voltage of the first secondary output terminal 11 of the transformer 10 is increased over a proper voltage, the voltage V_{H} transmitted from the TV monitor operation line 21 to the voltage detection circuit 24 is increased.

Thus, the voltage Vb applied to the base terminal 6b of the transistor 6 is increased, and a current that can be conducted from the collector 6c to the emitter 6e is increased. When a proper voltage is outputted from the second secondary output terminal 12 of the transformer 10,a current which conducts from the light emitting diode side input terminal 5a of the photo coupler 5 to the output terminal 5b is increased, and a feedback signal outputted from the detection signal output terminal 5c is increased.

And, due to the increasing of the feedback signal, an electric power inputted to the primary side input terminal 8 of the transformer 10 is controlled so as to be reduced. Accordingly, a voltage outputted from the secondary side output terminal 11 of the transformer 10 is reduced to be a proper voltage.

(2). Operation Example in a Waiting Mode

An operation example in a waiting mode for not operating a TV monitor will be explained. In a waiting mode, a voltage operating a TV monitor is outputted from the first secondary output terminal 11 of the transformer, and transmitted to the TV monitor operation line 21, but an electric power is not supplied to a TV monitor.

When a voltage of the first secondary side output terminal 12 of the transformer 10 is reduced to be lower than a proper voltage, a voltage applied to the microcomputer input line 22 is also reduced. When a proper voltage is outputted from the first secondary output terminal 11 of the transformer 10, a current which conducts from the light emitting diode side input terminal 5a of the photo coupler 5 to the output terminal 5b is reduced, and a feedback signal outputted from the detection signal output terminal 5c is reduced.

And, due to the reduction of the feedback signal, an electric power current inputted to the primary side input terminal 8 of the transformer 10 is controlled so as to increase. Accordingly, a voltage outputted from the secondary side output terminal 12 of the transformer 10 is increased to be a proper voltage.

Thus, in a waiting mode, a voltage of the secondary side output terminal 12 of the transformer 10 can be kept to be proper, at the time of moving to an operation mode, a control microcomputer can be operated normally. Thus, abnormal operations, such as a control microcomputer not being able to be operated normally, the power not being able o be turned ON, or a control microcomputer going out of control, can be prevented.

Thus, according to the power supply feedback circuit 20 in the present invention, especially in a waiting mode, when a voltage of the secondary side output terminal 12 of the transformer 10 is reduced to be lower than a proper voltage, such a situation can be detected precisely and the primary side of the transformer 10 is controlled, so that a voltage of the secondary side output terminal 12 of the transformer 10 can be maintained to be a proper voltage. Therefore, at the time of moving from a waiting mode to an operation mode, a control microcomputer can be operated normally.

With the above described power supply feedback circuit 20 according to the present invention, in case of moving between the operation mode and the waiting mode, a voltage of the first secondary side output terminal 11 and a voltage of the second secondary side output terminal 12 can be detected without switching a circuit for detecting a voltage of the secondary side of the transformer 10.

Thus, under the condition that the power supply feedback circuit does not become unstable, a voltage on the secondary side of the transformer 10 can be detected.

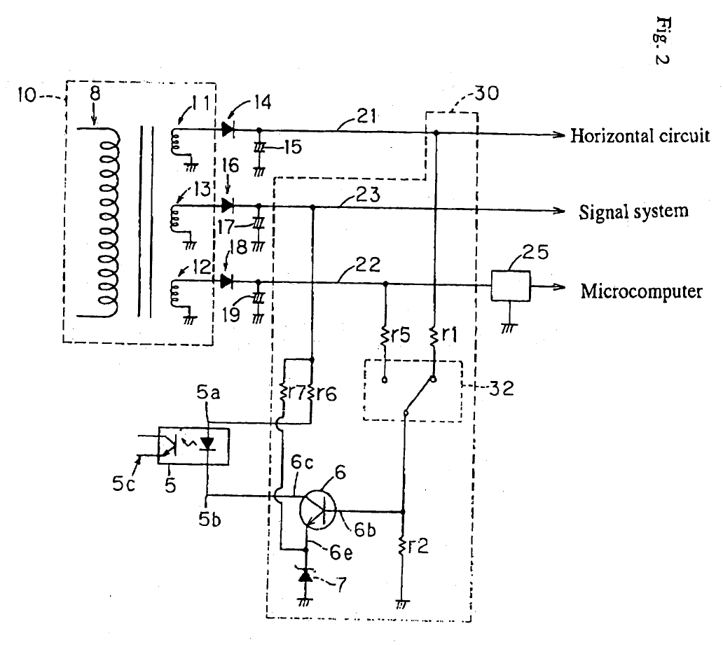

As explained heretofore, with the power supply feedback circuit according to the present invention, a voltage can be detected surely and stably. For purpose of comparison in this regard, explanations of a power supply feedback circuit not relying on the present invention will be made as follows. FIG. 2 shows a power supply circuit, as a comparative example, including a power supply feedback circuit 30 not relying on the present invention.

In FIG. 2, a numeral 10 represents a transformer which is provided with a primary side input terminal 8 and three secondary output terminals 11, 12, and 13, and is constituted in the same way as in the case explained referring to FIG. 1. An electric power to be inputted to a primary side of the transformer 10 is controlled by feedback signals outputted by a photo coupler 5.

A first secondary side output terminal 11 of the transformer 10 outputs an operating voltage for a TV monitor. A second secondary side output terminal 12 outputs an operating voltage for a microcomputer, and a third secondary side output terminal 13 outputs a voltage for signal systems.

And, the voltage outputted from the first secondary side output terminal 11 is inputted, via a TV monitor operation line 21, to a horizontal circuit of a TV monitor The voltage outputted from the second secondary side output terminal 12 is inputted, via a microcomputer input line 22, to a microcomputer. The voltage outputted from the third secondary side output terminal 13 is inputted, via a signal system operation line 23, to signal system circuits.

The power supply feedback circuit 30 in FIG. 2 is provided with a photo coupler 5 and a transistor 6 for detecting a voltage on the secondary side. And in FIG. 2, a detection line changing switch 32 is provided in order to change the connection to the transistor 6 between the TV monitor operation line 21 and the microcomputer input line 22. The changing switch 32, which may be constituted of a semiconductor switching element such as a transistor and the like, is changed with an order by a control microcomputer.

A contact point of the changing switch 32 is, in an operation mode, thrown to the side for connecting a base terminal 6b of the transistor 6 and the TV monitor operation line 21. In a waiting mode, the contact point of the changing switch 32 is thrown to the side for connecting the base terminal 6b and the microcomputer input line 22.

A light emitting diode side input terminal 5a of the photo coupler 5 is connected, via a resistor r6, to a signal system input line 23, and a light emitting diode side output terminal 5b of the photo coupler 5 is connected to a collector terminal 6c of the transistor 6.

The photo coupler 5 outputs a feedback signal from its output terminal 5c in response to a current which conducts from the input terminal 5a to the output terminal 5b. The current which conducts from the input terminal 5a to the output terminal 5b is determined by a current conducting from a collector 6c to an emitter 6e, and determined based on the Vb of the base terminal 6b of the transistor 6.

In the feedback circuit 30, a feedback signal outputted from the photo coupler 5 is determined by an operation condition of the transistor 6 on the basis of a voltage applied to the base terminal 6b of the transistor 6 and a voltage outputted to the signal system operation line 23.

And, the contact point of the changing switch 32 of the feedback circuit 30 is thrown, in an operation mode, to the side connecting the base terminal 6b of the transistor 6 to the TV monitor operation line 21, and the voltage V_{H} of the TV monitor operation line 21 is detected by the transistor 6 and the photo coupler 5.

And, when an operation mode is changed to a waiting mode, the contact point of the changing switch 32 is thrown to the side for connecting the base terminal 6b of the transistor 6 to the TV monitor operation line 21. Thus, a voltage of the microcomputer input line 22 is detected by the transistor 6 and the photo coupler 5.

In the feedback circuit 30, when an operation mode is changed to a waiting mode, a circuit connected to the transistor 6 is changed from TV monitor operation line 21 to the microcomputer input line 22, and there may be the case that the transistor 6 and the changing switch 32 cannot be stably operated.

Namely, since there exists a large difference between a voltage outputted to the TV monitor operation line 21 and a voltage outputted to the microcomputer input line 22, when a circuit connected to the transistor 6 is changed from the TV monitor operation line 21 to the microcomputer input line 22, the transistor 6 is taken into the state of instability for power supply oscillation due to the difference between the inputted voltages, thus resulting in unstable operation of the transistor 6.

And, in the changing switch 32, due to a large difference between a voltage outputted to the TV monitor operation line 21 and a voltage outputted to the microcomputer input line 22, the changing switch 32 brings about a flux of a power supply oscillation due to a difference between the inputted voltage, thus resulting in unstable operation of the changing switch 32.

In addition, by the aforesaid changing between the TV monitor operation line 21 and the microcomputer input line 22, there occurs a switching loss in the operation of the transistor 6 or the changing switch 32. Thus, there occurs useless power consumption, and the moment the changing is implemented, the transistor 6 is forced to do a steep control, thereby causing an unstable control. And, there occurs an oscillation stop of a power supply circuit, and a voltage drop is caused in power supply voltage of a microcomputer.

In the power supply feedback circuit 30 shown in FIG. 2, when a voltage of the microcomputer input line 22 fluctuates under the condition that the aforesaid transistor 6 and the changing switch 32 are unstably operated, the transistor 6 and the photo coupler 5 cannot detect the fluctuation.

Accordingly, when a voltage of the microcomputer input line 22 fluctuates under the condition that the aforesaid transistor 6 is operated unstably, the photo coupler 5 cannot output a feedback signal to the primary side of the transformer 10, so that the photo coupler 5 cannot control the transformer 10.

On the other hand, in the power supply feedback circuit 20 according to the present invention, as already explained with the accompanying drawing FIG. 1, a circuit for detecting a voltage of the secondary side of the transformer 10 is not changed between the operation mode and the waiting mode, and there does not cause unstable operation such as caused in the aforesaid feedback circuit 30. As a result, there causes no unstable operation which occurred in the case of the aforesaid feedback circuit 30.

Thus, the present power supply feedback circuit 20 detects a voltage fluctuation of the secondary side of the transformer 10 stably and surely and outputs a feedback signal, thereby controlling the transformer 10 surely.

Moreover, according to the power supply feedback circuit 20 related to the present invention, a switching loss is not caused in the switching element such as a transistor or the like, and the occurrence of the useless consumption of a electric power is prevented.

Also, according to the power supply feedback circuit related to the present invention, as it is not required to change a circuit for detecting a voltage of the secondary side of the transformer between the operation mode and the waiting mode, it is not required to provide the switching element such as the transistor or the like for changing the circuit. Thereby, the feedback circuit can be made compact, and manufacturing costs for it can be reduced.

In the above explanation with respect to the power supply feedback circuit 20 according to the present invention, the example in which the photo coupler 5 is used as the feedback signal output element is explained, and the example in which the transistor 6 is used as the semiconductor control element is explained.

In constituting the power supply feedback circuit according to the present invention, an element other than a photo coupler may be applied as a feedback signal output element. That is, any element, in which a current is conducted in response to a detected voltage, and from which a feedback signal is response to the current is outputted, may be used.

However, applying a photo coupler is preferable, because, due to the relation between a detected voltage, a conductive current, and feedback signals, the transformer can be easily controlled on the basis of the relation between the detected voltage and feedback signal.

Further, in constituting the power supply feedback circuit according to the present invention, though the example in which the semiconductor control element is constituted of a NPN-typed transistor is explained in the above explanation, the semiconductor control element may be constituted of a PNP-typed transistor.

Further, as a semiconductor control clement, a semiconductor element other than a transistor may be used as far as an operation condition can be varied depending on a detected voltage and a current of a feedback signal output element can be controlled. For example, a FET (Field-Effect Transistor) may be used.

### INDUSTRIAL APPLICABILITY

As explained heretofore, the power supply feedback circuit according to the present invention can detect a voltage, which operates a TV monitor and is outputted from a secondary side of a transformer provided to a power supply circuit and surely detects a fluctuation of an output voltage of a secondary side of a transformer for operating a control microcomputer, thereby surely controlling an output of a transformer.

Thus, a control microcomputer can be operated normally with sureness, thus leading to a normal operation of a TV monitor.

What is claimed is:

1. A power supply feedback circuit:
connected to a power supply circuit for a TV monitor which has a transformer having a primary side input terminal, a first secondary side output terminal for outputting a voltage for operating a TV monitor and a second secondary side output terminal for outputting a voltage for operating a control microcomputer,
wherein said power supply feedback circuit detects a voltage of said first secondary side output terminal and a voltage of said second secondary side output terminal and outputs a feedback signal for controlling an electric power for said primary input terminal of said transformer, and
provided with a feed back signal output element which outputs said feedback signal in response to a conducting current and a semiconductor control element which controls said feedback signal output element; and
wherein said feedback signal output element is connected to said second secondary side output terminal and is connected so as to be supplied a current in response to the voltage of said second secondary side output terminal, and
wherein said semiconductor control element is connected to detect the voltage of said first secondary side output terminal and so as to control the current conducting said feedback signal output element in response to the detected voltage of said first secondary side output terminal.

2. A power supply feedback circuit claimed in claim 1, wherein said feedback signal output element can be connected, via a voltage absorption element inducing a certain amount of voltage drop, to said second secondary side output terminal.

3. A power supply feedback circuit claimed in claim 1, wherein said feedback output element can be constituted of a photo coupler.
